(19) United States
(12) Patent Application Publication
(10) Pub. No.: US 2025/0141695 A1
(43) Pub. Date: May 1, 2025

(54) SYSTEMS AND METHODS OF LAYERING SECURITY FOR CELLULAR-ENABLED USER WEIGHT DATA TRANSMISSION

(71) Applicant: Smart Meter Corporation, Tampa, FL (US)

(72) Inventor: Benjamin Atkin, Bergenfield, NJ (US)

(73) Assignee: Smart Meter Corporation, Tampa, FL (US)

(21) Appl. No.: 18/985,676

(22) Filed: Dec. 18, 2024

Related U.S. Application Data
(63) Continuation-in-part of application No. 17/517,866, filed on Nov. 3, 2021.
(60) Provisional application No. 63/113,565, filed on Nov. 13, 2020.

(51) Int. Cl. H04L 9/32; H04L 9/06; H04L 9/40

(52) U.S. Cl. CPC H04L 9/3252; H04L 9/0618; H04L 63/166

(57) ABSTRACT

A system for secure weight data transmission comprising: a scale; a wireless network connected to the scale; a private network connected to the wireless network via a persistent and fully redundant IPsec VPN tunnel; one or more computer processors; and a memory storing instructions, that when executed by the one or more processors, cause the system to: collect, initial weight data from a patient; encrypt, the initial weight data with a shared secret, wherein encrypting the initial weight data creates encrypted weight data; generate, a first hash using a signing algorithm; transmit, the encrypted weight data from the scale to the private network; generate, a second hash; compare, the first hash to the second hash; decrypt, the encrypted weight data upon a match of the first and second hash, wherein decrypting the encrypted weight data creates verified weight data; and transmit, the verified weight data to a target recipient.

### CROSS REFERENCE TO RELATED APPLICATIONS

The present application claims the benefit of U.S. patent application Ser. No. 17/517,866 for DIGITAL WEIGHT SCALE WITH CELLULAR COMMUNICATIONS, filed Nov. 3, 2021, and U.S. Patent Application No. 63/113,565 for DIGITAL WEIGHT SCALE WITH CELLULAR COMMUNICATIONS, filed Nov. 13, 2020, the entire contents of which are incorporated herein by reference.

### FIELD OF THE DISCLOSURE

The present disclosure is directed to a digital weight scale. In particular, the field of the disclosure and its embodiments relate to a digital weight scale with cellular communication capabilities.

### INTRODUCTION

Scales determine weight by measuring the amount of force required to oppose an object's acceleration due to gravity. Scales may be used to weigh raw materials, reagents, food items, and humans. Further, scales may be mechanical and digital. Mechanical scales typically use a spring, where, when weight is applied to the scale, measurement is shown by a moving dial. These scales allow for quick and easy-to-read measurements. Digital scales employ the use of a special electrical circuit. As a weight is applied to the digital scale, the voltage within the circuit changes and a processor calculates the weight. Digital scales are more accurate than mechanical scales, can provide multiple units of measure, and can often be connected to a computer for easy processing of data.

In the household setting, digital weight scales measure numerous health parameters of the individual, such as the weight, body mass index (BMI), body fat percentage, bone mass, and muscle mass, among others. However, such scales fail to provide additional functionality that is necessary for a user to track one's health and/or chronic health conditions.

### SUMMARY

This Summary is provided to introduce a selection of concepts in a simplified form that are further described below in the Detailed Description. This Summary is not intended to identify key features or essential features, nor is it intended to limit the scope of the claims included herewith.

Provided may be a system for improving the security of cellular-enabled weight data transmission by layering security. In an embodiment, the system comprises a scale; a wireless network connected to the scale; a private network connected to the wireless network via a persistent and fully redundant Internet Protocol Security (IPsec) Virtual Private Network (VPN) tunnel; one or more computer processors; and a memory having stored therein machine executable instructions, that when executed by the one or more processors, cause the system to: collect, via the scale, initial weight data from a patient; encrypt, via the scale, the initial weight data with a shared secret, wherein encrypting the initial weight data creates encrypted weight data; generate, via the scale, a first hash using a signing algorithm; transmit, via the persistent and fully redundant IPsec VPN tunnel, the encrypted weight data from the scale to the private network; generate, via the private network, a second hash; compare, via the one or more computer processors, the first hash to the second hash; decrypt, via the one or more computer processors, the encrypted weight data upon a match of the first and second hash, wherein decrypting the encrypted weight data creates verified weight data; and transmit, via the one or more computer processors, the verified weight data to a target recipient.

In another embodiment, the shared secret is a symmetric-key algorithm comprising: a key; and a symmetric block cipher. Additionally, the key is comprised of at least one of a 128-bit key, a 256-bit key, a 576-bit key, and a 2040-bit key. Furthermore, the symmetric block cipher is comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher. Moreover, the persistent and fully redundant IPsec VPN tunnel leverages the symmetric-key algorithm to encrypt the encrypted weight data while travelling through the persistent and fully redundant IPsec VPN tunnel.

In a further embodiment, the scale connects to the wireless network via an Access Point Name (APN). Additionally, the persistent and fully redundant IPsec VPN tunnel is further comprised of Transport Layer Security (TLS).

In yet a further embodiment, the verified weight data is transmitted to one or more client devices of the target recipient. Lastly, the signing algorithm is comprised of at least one of a Rivest-Shamir-Adleman (RSA) algorithm, an EIGamal signature scheme, a Digital Signing Algorithm (DSA), and an Elliptical Curve Digital Signature Algorithm (ECDSA).

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 depicts a block diagram of a system utilizing a body weight scale in a data communication network, according to at least some embodiments described herein.

FIG. 2 depicts a block diagram of components of a body weight scale, according to at least some embodiments described herein.

FIG. 3 depicts a block diagram of a memory component of a body weight scale, according to at least some embodiments described herein.

FIG. 4 depicts a schematic diagram of an interactive display for a body weight scale, according to at least some embodiments described herein.

FIG. 5 depicts a schematic diagram of an interactive display for a body weight scale, according to at least some embodiments described herein.

FIG. 6 depicts a schematic diagram of an interactive display for a body weight scale, according to at least some embodiments described herein.

FIG. 7 depicts a schematic diagram of an interactive display for a body weight scale, according to at least some embodiments described herein.

FIG. 8 illustrates an embodiment of a system of layering security for cellular-enabled user weight data transmission.

FIG. 9 illustrates an embodiment of a method of layering security for cellular-enabled user weight data transmission.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

The preferred embodiments of the present disclosure will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

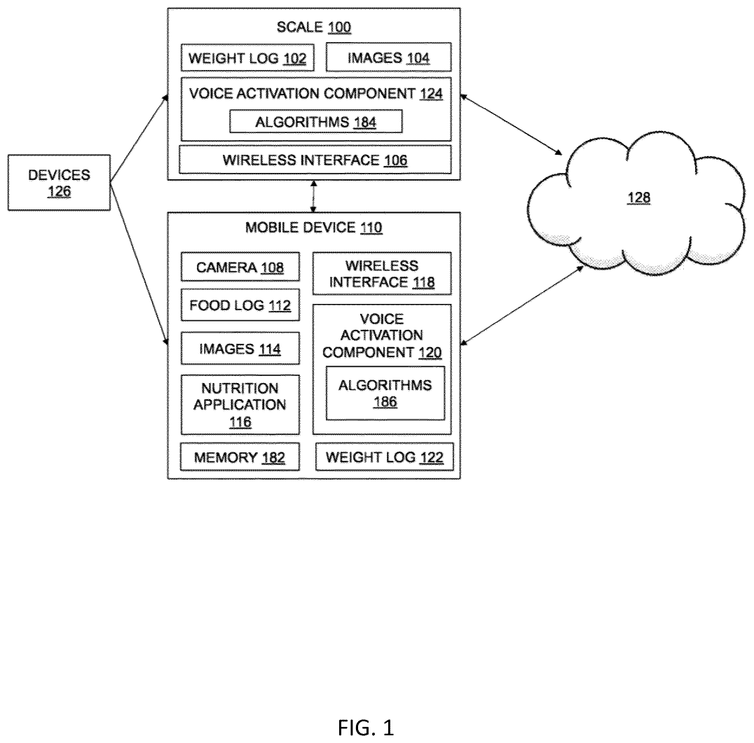

A system utilizing a body weight scale in a data communication network is depicted in at least FIG. 1. The system shown in FIG. 1 provides a comprehensive way for one or more individuals to track their weight and nutrition over time. The system of FIG. 1 includes a scale 100 (e.g., a body weight scale), a mobile device 110, and a data network 128. It should be appreciated that the scale 100 may accommodate over 500 pounds during weight measurements. The mobile device 110 may be a computer, a laptop computer, a smartphone, and/or a tablet, among other examples not explicitly listed herein.

Although the embodiment described in FIG. 1 depicts only two connected devices, the system of FIG. 1 may include a number of additional connected devices 126, providing data input to the scale 100, such as blood pressure cuffs, electrocardiogram (ECG) monitors, heart rate monitors, activity monitors, pedometers, and other such devices. These additional devices may also be connected to the mobile device 110, in examples. The additional connected devices 126 may also be part of a larger system of health tracking for the general wellness of the individual or to track chronic conditions, such as asthma, hypertension, diabetes, obesity, and others.

The scale 100 and the mobile device 110 each have wired or wireless data communication capabilities. The scale 100 may have a wireless interface 106 and the mobile device 110 may have a wireless interface 118. The wireless interface 106 and the wireless interface 118 may include one or more of Wi-Fi connections, Near Field (NFC) connections, Bluetooth® connections, Bluetooth® Low Energy (Bluetooth LE) connections, GSM or CDMA cellular communications, or other wireless protocols. It should be appreciated that the scale 100 and the mobile device 110 may each be capable of more than one type of wireless communication over the data network 128.

Wireless LANs (WLANs), in which a mobile user can connect to a local area network (LAN) through a wireless connection, may be employed for wireless communications. Wireless communications can include communications that propagate via electromagnetic waves, such as light, infrared, radio, and microwave. There are a variety of WLAN standards that currently exist, such as Bluetooth®, Bluetooth LE, and IEEE 802.11.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware, or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

As described herein, “NFC” is a set of communication protocols for communication between two electronic devices over a distance of 4 cm or less. NFC devices can act as electronic identity documents and keycards and may be used in contactless payment systems and allow mobile payment replacing or supplementing systems such as credit cards and electronic ticket smart cards. NFC can be used for sharing small files such as contacts and bootstrapping fast connections to share larger media such as photos, videos, and other files.

As shown in FIG. 1, the scale 100 further includes a weight log 102, which includes weight information measured over a period of time for a given user/individual. In a preferred embodiment, the scale 100 includes multiple weight logs for multiple users of the scale 100. The scale 100 may identify and distinguish between different users of the scale 100 (such as a first user and a second user) in numerous ways, since each user's scale activity is tracked independently.

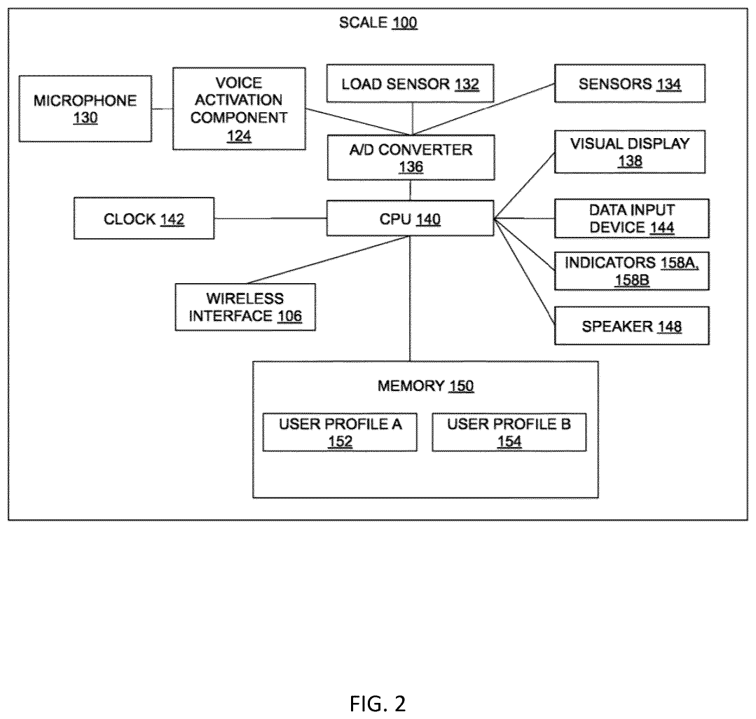

In a first example, the scale 100 may distinguish between the first user and the second user based on recognizing the weight of a given individual on the scale 100 and predicting the correct user based on the weight. More specifically, a load sensor 132 (of FIG. 2) of the scale 100 may capture a body weight of an individual. An analog-to-digital converter 136 (of FIG. 2) of the scale 100 converts the body weight of the individual to a digital weight. Then, the scale 100 is configured to compare the digital weight of the individual to a first group of weights associated with a first user profile A 152 (associated with a first user) (of FIG. 2) stored in a physical, non-transitory memory 150 (e.g., the memory 150) (of FIG. 2) of the scale 100 and compare the digital weight of the individual to a second group of weights associated with a second user profile B 154 (associated with a second user) (of FIG. 2) stored in the memory 150. The scale 100 is then configured to determine whether the digital weight is closer to the first group of weights associated with the first user profile A 152 or the second group of weights associated with the second user profile B 152. In an example where the scale 100 determines that the digital weight is closer to the first group of weights associated with the first user profile A 152, the scale 100 predicts that the individual is the first user. In other examples, the scale 100 is configured to determine that the digital weight is closer to the second group of weights associated with the second user profile B 154 and predict the individual as being the second user.

In another embodiment, the mobile device 110 may send a signal to the scale 100 when the mobile device 110 is in proximity to the scale 100. In this second embodiment, the scale 100 receives the signal from mobile device 110 and selects the weight log corresponding to the owner of the mobile device 110.

Alternately, a key fob (not shown) could contain wireless signal capabilities to send a signal to the scale 100 to select a particular weight log. It should be appreciated that a “key fob” is a security device with built-in authentication used to control and secure access to network services and data. Such key fob could also be used to signal to the scale 100 that a particular user is in close proximity to the scale 100, which could, in turn, signal the scale 100 to perform specific tasks unique to that scale user.

In another illustrative example, the scale 100 may distinguish between the first user and the second user based on login credentials of the given user. For example, when the given user (e.g., the first user) interacts with the scale 100, the first user may be prompted to provide login credentials to determine an identity of the given user engaging with the scale 100. Such login credentials may be provided to a microphone 130 (of FIG. 2) via audio input and/or via physical input through a data input device 144 (of FIG. 2) of the scale 100. The data input device 144 of the scale 100 may include a keyboard, mouse, touch screen, or other controller to allow the given user to input information into the scale 100. It should be appreciated that the login credentials are not limited to any particular type or configuration of credentials.

In the example where the first user provides the audio input, the microphone 130 of the scale 100 receives the login credentials via the audio input. Next, one or more algorithms 184 of a voice activation component 124 (of FIG. 1 and FIG. 2) of the scale 100 analyzes the login credentials to determine whether the login credentials corresponds to login credentials associated with a user profile stored in the memory 150 of the scale 100 (such as the first user profile A 152 associated with the first user, or the second user profile B 154 associated with the second user). In response to a determination that the login credentials of the audio input correspond to the login credentials associated with the first user profile A 152, the one or more algorithms 184 of the voice activation component 124 confirm the identity of the user as the first user.

In the example where the user provides the login credentials via the physical input through the data input device 144, if the login credentials correspond to login credentials associated with a user profile stored in the memory, the identity of the given user is confirmed. If the identity of the given user is not confirmed via the audio input or the physical input, the given user is prompted to create a user profile on the scale 100 or the mobile device 110 via audio input and/or physical input. Responsive to creation of such profile, the created profile is stored in a memory 182 of the mobile device 110 and/or the memory 150 of the scale 100.

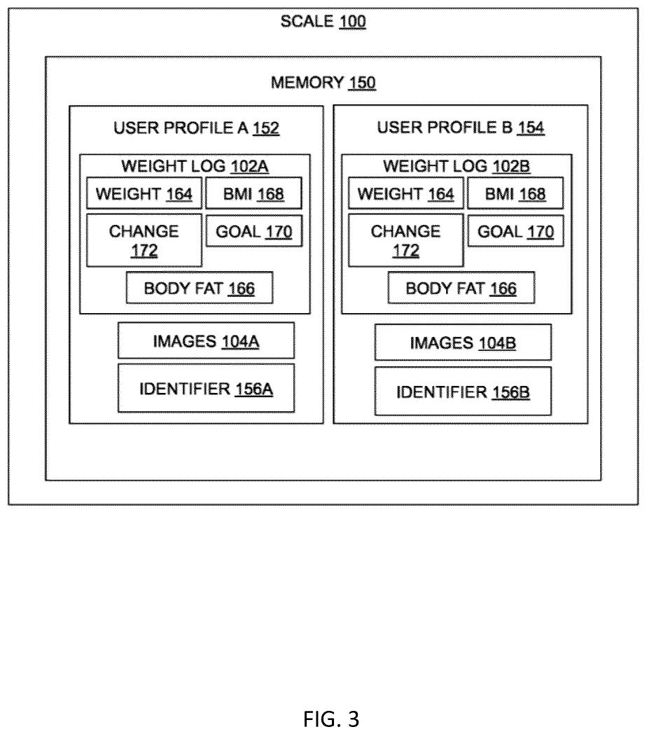

It should be appreciated that the weight log 102 may be updated with a new log entry every time a particular individual uses the scale 100. In an illustrative example, the weight log 102 may be updated with the new log entry every time the particular individual steps off the scale 100. Such weight log 102 may be updated multiple times a day, daily, weekly, monthly, etc., As shown in FIG. 3, the weight log 102 may include information such as a weight 164 of the given user, an age of the given user, a height, an amount of body fat 166 of the given user, a body mass index (BMI) 168 of the given user, a goal or target weight 170 of the given user, a weigh-in date and time, and other physical health-related data of the given user. It should be appreciated that the BMI 168 is the person's weight in kilograms divided by the square of height in meters. A high BMI can be an indicator of high body fatness. BMI can be used to screen for weight categories that may lead to health problems. The health-related data is preferably measured and stored in weight log 102 at regular intervals, such as every time the given user weighs-in on the scale 100.

The scale 100 may communicate directly or indirectly with mobile device 110. In an example, a nutrition software application 116 (of FIG. 1) is executed on the mobile device 110. It should be appreciated that in other examples, the nutrition software application 116 may be an engine, a software program, a service, or a software platform executable on the mobile device 110. The user may input food information into the nutrition software application 116, which may be stored in a food log 112 (of FIG. 1). The nutrition software application 116 may also receive, from the user, weight data from the scale 100. In response, the nutrition software application 116 may store the weight data in a weight log 122 (of FIG. 1). It should be appreciated that the nutrition software application 116 may, in addition to tracking food and weight data, track physical activity data of the user. The nutrition software application 116 also allows the first user or the second user to share data and progress with another user, such as a workout partner or a trainer.

Specifically, in examples, the scale 100 may comprise a cellular modem (not shown) to communicate and/or transmit measurement results to the mobile device 110 or another computing device, such as a smartphone, a laptop computer, a tablet, or another suitable computing device. It should be appreciated that, as described herein, the cellular modem is a device that adds cellular connectivity to laptops, desktop computers, tablets, and other similar devices. Furthermore, it should be appreciated that the cellular modem replaces the existing BLE module in the Bluetooth devices described herein.

In examples, the cellular modem may be embedded within the scale 100 or may be a standalone device that is connected to the scale 100 through various means, including, but not limited to, a USB connection. Examples of cellular modems include, but are not limited to, AT&T Momentum, Verizon 551 L, USB cellular modems and motherboard mounted cellular chipsets manufactured by Novatel Wireless, Sierra Wireless, Huawei, and the like. In other examples, the cellular modem may operate by switching between cellular and satellite communications.

Furthermore, the cellular modem may be configured to automatically connect to a slower network when the faster network is not available. The cellular modem may also monitor the reliability of all available connections. The reliability of a network can be determined from information collected by the cellular modem, which includes, but is not limited to, signal strength, quality, availability, packet loss, retransmits, packet latency, throughput speed, and other cell tower signaling quality factors. The cellular modem may then compare this information in various forms to a reliability threshold in order to determine whether or not to maintain or terminate a connection to a cellular network. The reliability threshold is often automatically set by the cellular carrier or may be manually set by the user of the scale 100.

Further, it should be appreciated that the cellular modem is also configured to establish a connection with cellular networks in which the cellular modem is located. The cellular modem is configured to monitor and detect all cellular networks as the cellular modem moves from one network coverage area to another network coverage area via a vehicle in which it is contained. The cellular modem can detect when a connection to a particular network is made, whether it is a 3G, 4G, or 5G network, as well as which cellular network provider (e.g., Verizon, T-Mobile, etc.) it has connected to.

In some examples, the mobile device 110 comprises a digital camera 108 (of FIG. 1) that allows food images 114 (of FIG. 1) to be captured and stored in the memory 182 of the mobile device 110. In the preferred embodiment, the images 114 correspond to foods that the user has eaten, and each image 114 is associated in the food log 112 with one or more food log entries for a specific date and time. The scale 100 may receive the images 114 from the mobile device 110 and may store the images 114 as images 104 (of FIG. 1) in connection with the weight log 102 of scale 100. The images 104 may later be displayed to the scale user, as will be discussed herein.

A block diagram of components of the scale 100 is depicted in FIG. 2. The scale 100 contains numerous internal components for functioning within the system of FIG. 1. For example, the scale 100 includes a central computer processor (CPU) 140 connected to the physical, non-transitory memory 150 (e.g., the memory 150). A wireless communication interface 106 provides data communication connectivity to the data network 128 (of FIG. 1).

The memory 150 stores user data, such as water weight, lean weight, body fat percent, body mass index, etc. The elements stored in memory 150 may be also synchronized and stored remotely in a cloud-based storage. Such data may be stored in the first user profile A 152 associated with the first user and in the second user profile B 154 associated with the second user. It should be appreciated that numerous profiles may be stored in the memory 150 and the quantity of the profiles is not limited to two.

As shown in FIG. 3, each of the user profiles (e.g., the first user profile A 152 and the second user profile B 154) may include a unique identifier associated with the user of the profile. For example, a first identifier 156A may be associated with the first user and may be stored in the first user profile A 152 and a second identifier 156B may be associated with the second user and may be stored in the second user profile B 154. For illustrative purposes only, the unique identifier may be a numerical code, an alphanumeric code, a username, etc. Each of the first user profile A 152 and the second user profile B 154 may also include the weight log 102 unique to that user and images of food eaten by the specific user. Specifically, the first user profile A 152 may include a weight log 102A and the images 104A associated with the first user and the second user profile B 154 may include a weight log 102B and the images 104B associated with the second user.

The scale 100 may also include numerous sensors and input devices. For example, the scale 100 may include the load sensor 132 (of FIG. 2) that, as explained supra, captures the body weight, which is converted to the digital weight signal by the analog-to-digital converter 136 (of FIG. 2). The scale 100 may further include one or more sensors 134 (of FIG. 2). The one or more sensors 134 may include: body fat sensors, blood pressure cuffs, ECG monitors, heart rate monitors, and other such sensors for detecting physical and/or biometric measurements for a scale user. Moreover, as shown in FIG. 2, the scale 100 may include a speaker 148 and a visual display 138 that provides output and/or feedback to the user. The scale 100 may further comprises a clock 142 to determine weigh-in date and time for a particular scale user.

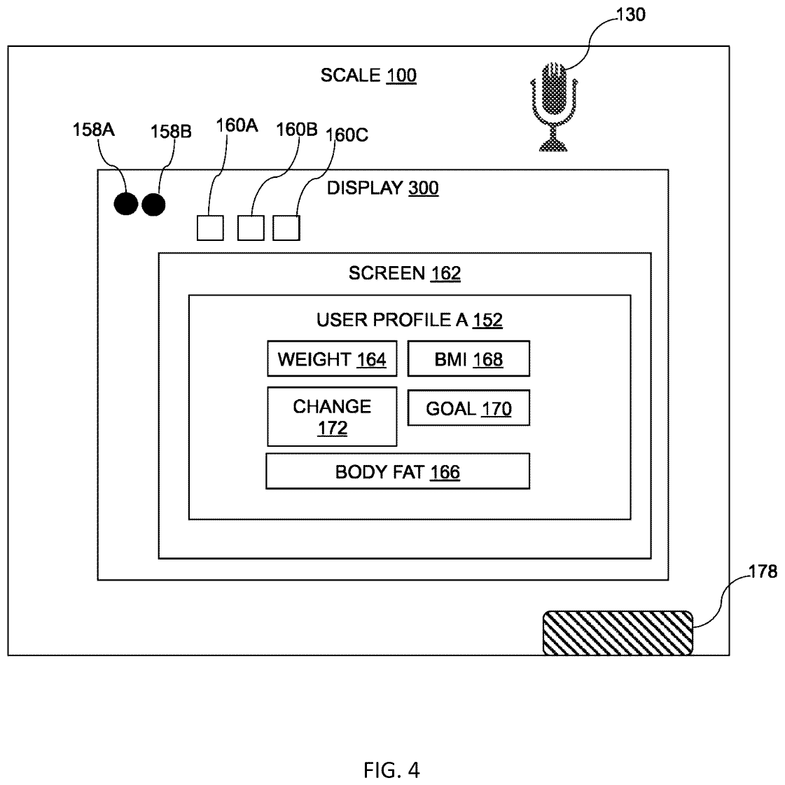

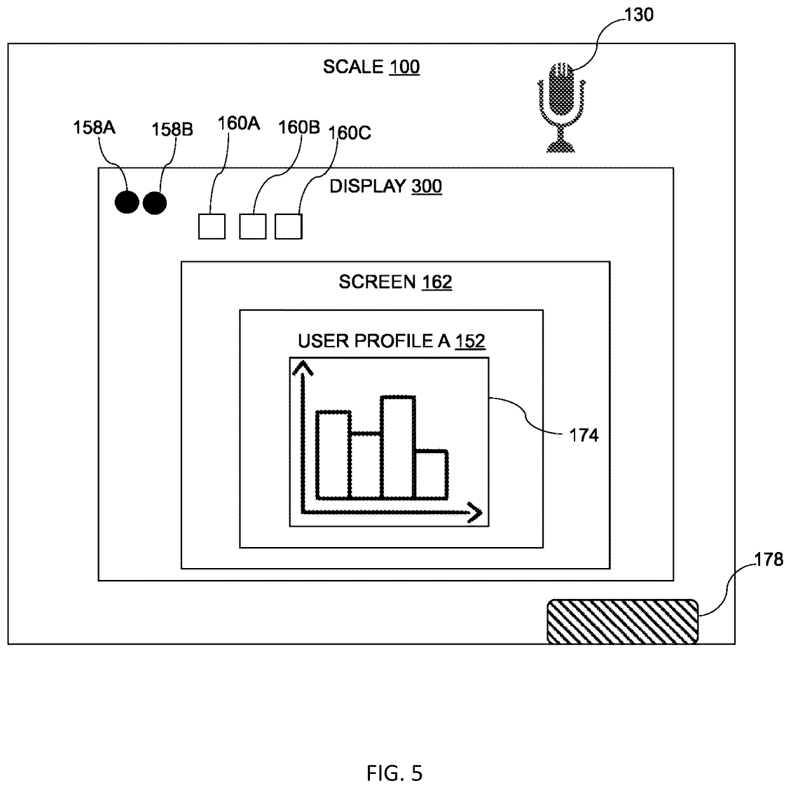

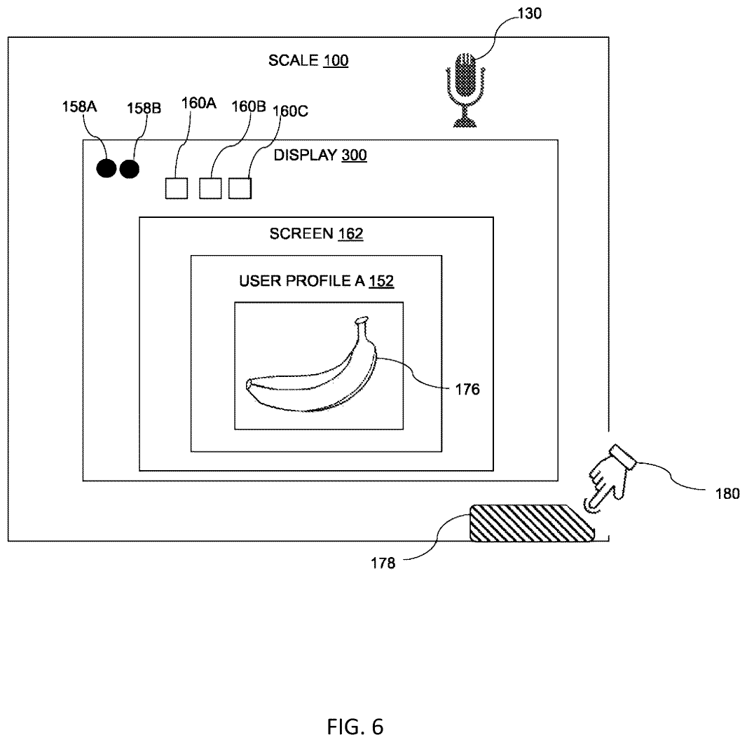

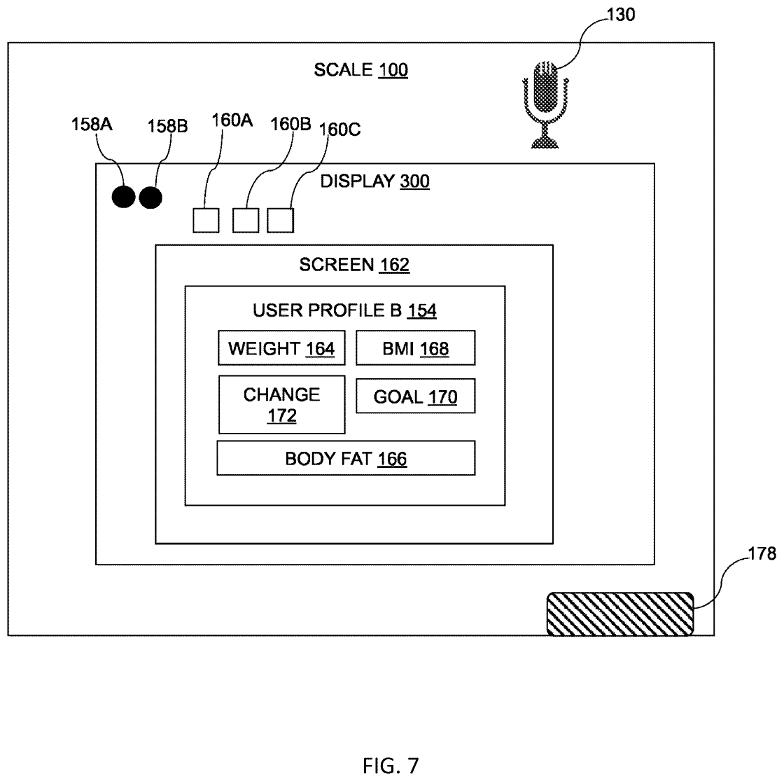

FIG. 4, FIG. 5, FIG. 6, and FIG. 7 depict schematic diagrams of an interactive display 300 for the scale 100. It should be appreciated that the interactive display 300 may have additional or fewer features from the ones described and depicted herein. In one embodiment, the interactive display 300 is touch-enabled.

The interactive display 300 allows the user to view data described herein in numerous ways. In an example, the interactive display 300 provides a screen 162 that changes based on user selection of a button, such as a first button 160A, a second button 160B, or a third button 160C. Upon user selection of the first button 160A, the screen 162 of the scale 300 displays the user profile associated with the given user. For example, as shown in FIG. 4, the screen 162 displays the first user profile A 152 of the first user that shows a current weight 164 for the given scale user, a current body fat percentage 166, a current BMI 168, the goal/target weight 170, and a change in weight 172 since the most recent user weigh-in. Other raw scale data could also be displayed.

Upon selection of the second button 160B, and as depicted in FIG. 5, the screen 162 of the scale 100 displays a graph 174 of previous weight data. Such graph 174 allows the user to view the user's change in weight over a period of time. Upon selection of the third button 160C, and as shown in FIG. 6, the screen 162 of the scale 100 displays images (such as an image 176) of foods eaten by the individual. In one example, the images are images of foods that the user has eaten within a specific time period. In an example, the images may be images received from mobile device 110 for foods eaten by the given user within the past 7 days, or past 24 hours, or other specific time period. In additional examples, other buttons may be present. For example, a message button, upon selection, may display encouraging messages via the screen 162 to the user for the user to meet the user's goal.

In another example, the scale 100 may include a switch component 178 (of FIG. 4, FIG. 5, FIG. 6, and FIG. 7). The switch component 178 may receive an action 180 (as shown in FIG. 6), such as a touch or tap action by a users' hand, finger, or foot, indicating that the first user wishes to switch display on the screen 162 to another profile or to other information.

In other examples, voice activation may be used to prompt the scale 100 to perform an action, such as display the first user profile A 152 associated with the first user or display different items or information associated with the first user profile A 152 on the screen 162. Voice activation may also be used to perform actions on the mobile device 110. As explained, the scale 100 comprises the voice activation component 124 (or module) and the mobile device 110 comprises the voice activation component 120 (or module). The voice activation component 124 may be used to control actions of the scale 100 and the voice activation component 120 may be used to control actions of the mobile device 110, respectively.

Further, the voice activation component 124 of the scale 100 comprises the one or more algorithms 184 and the voice activation component 120 of the mobile device 110 comprises the one or more algorithms 186. In an example, when the microphone 130 of the scale 100 receives an audio input from the user, the one or more algorithms 184 of the voice activation component 124 analyze the audio input to determine whether the audio input corresponds to a command recognizable by the voice activation component 124. Such recognizable commands are stored in the memory 150 of the scale 100. In other examples, the recognizable commands are stored in a data store (not shown). If the voice input corresponds to a recognizable command, the scale 100 may process and execute the command.

Similarly, when the microphone (not shown) of the mobile device 110 receives an audio input from the user, the one or more algorithms 186 of the voice activation component 120 analyze the audio input to determine whether the audio input corresponds to a command or macros recognizable by the voice activation component 120. Such recognizable commands are stored in the memory 182 or a data store (not shown) of the mobile device 110. If the voice input corresponds to a recognizable command, the mobile device 110 may process and execute the command.

The command can include any of a number of functions or operations supported by scale 100 or the mobile device 110. It should be appreciated that the recognizable commands may include: turn on the device, turn off the device, awake the device from a sleep mode, put the device into the sleep mode, display the first user profile A 152, display the second user profile B 154, display the graph 174 from the first user profile A 152 via the screen 162, display the images of food eaten by the given user within a specified time period, measure and display the current weight 164 for the given scale user, measure and display the current body fat percentage 166 for the given scale user, measure and display the current BMI 168 for the given scale user, display the goal/target weight 170 for the given user, display the change in weight 172 for the given user since the most recent user weigh-in, etc., It should be appreciated that the scale 100 and the mobile device 110 may utilize user input devices to replace or supplement voice commands.

It should be appreciated that in some implementations, the mobile device 110 may comprise an intelligent personal assistant and knowledge manager, such as Siri, and/or a virtual assistant artificial intelligence (AI) technology developed by Amazon, Amazon Alexa. In this example, the mobile device 110 may first receive, via the data input device 114, an action on a physical button, icon, or display of the mobile device 110. In response, the mobile device 110 may launch Siri or Amazon Alexa. Then, the user may provide audio input, via the microphone, to the mobile device 110. Siri or Amazon Alexa may process the audio input and provide an audio or a visual response. In some examples, the audio or visual response may be transmitted to the scale 100 for storage and/or display to the user.

As described herein, “Siri” is a software application, and more particularly, an intelligent personal assistant and knowledge manager. Siri is part of Apple Inc.'s iOS, iPadOS, watchOS, macOS, and tvOS operating systems. The assistant uses voice queries, gesture based control, focus-tracking and a natural-language user interface to answer questions, make recommendations, and perform actions by delegating requests to a set of Internet services. The software adapts to users' individual language usages, searches, and preferences, with continuing use. Returned results are individualized. Siri supports a wide range of user commands, including performing phone actions, checking basic information, scheduling events and reminders, handling device settings, searching the Internet, navigating areas, finding information on entertainment, and is able to engage with iOS-integrated apps.

As described herein, “Amazon Alexa” or “Alexa” is a virtual assistant AI technology developed by Amazon. Alexa is capable of voice interaction, music playback, making to-do lists, setting alarms, streaming podcasts, playing audiobooks, and providing weather, traffic, sports, and other real-time information, such as news. Alexa can also control several smart devices using itself as a home automation system. Users are able to extend the Alexa capabilities by installing “skills” (additional functionality developed by third-party vendors, in other settings more commonly called apps such as weather programs and audio features).

Moreover, the display 300 of the scale 100, as shown in FIG. 4, FIG. 5, FIG. 6, and FIG. 7, may also include one or more indicators 158A, 158B to remind an individual to weigh-in on the scale 100 and to provide a means for driving adherence of scale use. Further, in examples, the one or more indicators 158A, 158B may be one or more light-emitting diodes (LEDs) of various colors. The one or more indicators 158A, 158B may be used in a number of ways.

The one or more indicators 158A, 158B may flash, strobe, or change color. In another example, the first user associated with the first user profile A 152 may be assigned a color of green and the second user associated with the second user profile B 154 may be assigned a color of red. Such colors may be stored in the respective user profile. If the first user, for example, fails to use the scale for more than a specified time period (e.g., a week), the one or more indicators 158A, 158B may flash the color green at a low duty-cycle. In the same example, if the second user fails to use the scale for more than a specified time period, the one or more indicators 158A, 158B may flash the color red at a low duty-cycle. The duty-cycle may increase successively as more time elapses between consecutive weigh-ins by the scale user.

In an alternate configuration, the one or more indicators 158A, 158B may appear as a first color for the given user when the individual is weighed on the scale. After a predetermined amount of time, if the user has not used the scale, the one or more indicators 158A, 158B may change to a second color. Later, if the user has not used the scale after a second predetermined time, the one or more indicators 158A, 158B would change to a third color.

In this example, the one or more indicators 158A, 158B may initially appear green in color to the first user when the individual is weighed on the scale. After a predetermined amount of time (e.g., a week), if the first user has not used the scale, the one or more indicators 158A, 158B change from the green color to a gray color. Later, if the first user has not used the scale after a second predetermined time (e.g., a month), the one or more indicators 158A, 158B would change from the second color of gray to a third color, black.

In one embodiment, the mobile device 110 may send a user-identifying signal to the scale 100 when the mobile device 110 is in proximity to scale 100. In an alternate embodiment, the one or more indicators 158A, 158B may also include audio indicators. In this embodiment, the one or more indicators 158A, 158B illuminate or sound (e.g., a tone, a beep, an alarm, etc.) when mobile device 110 is in proximity to the scale 100.

Furthermore, as depicted in at least FIG. 4, FIG. 5, FIG. 6, and FIG. 7, the one or more indicators 158A, 158B are located on a same surface as the display 300. In another example, the one or more indicators 158A, 158B may be located on a different surface of the scale 100, such that the one or more indicators 158A, 158B face the ground when the scale 100 is in use. In this example, when on, the one or more indicators 158A, 158B may create light around the bottom of the scale 300. In a further example, the one or more indicators 158A, 158B may be located around the periphery of the scale 100. In this example, if the periphery of the scale 100 were glowing green, the first user associated with the green color would know that it is time to use the scale 100.

If a predetermined amount of time has passed (e.g., a week), the color of the one or more indicators 158A, 158B may pulse to indicate that it has been longer than the predetermined amount of time since the given user has taken a measurement using the scale 100. The pulse could then turn into an on-off flashing pattern after a longer period of time has elapsed (e.g., two weeks). In an embodiment, if the user utilizes the key fob to communicate to the scale 100 that the user is present, the one or more indicators 158A, 158B may increase light intensity for the user identified by the key fob.

Another embodiment of the disclosure provides a method that performs the process steps on a subscription, advertising, and/or fee basis. That is, a service provider can offer to assist in the method steps described herein. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

The data network 128 may employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for mobile devices, such as client devices with various degrees of mobility. For example, the data network 128 may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. The data network 128 may include virtually any wireless communication mechanism by which information may travel between mobile devices and another computing device, network, and the like.

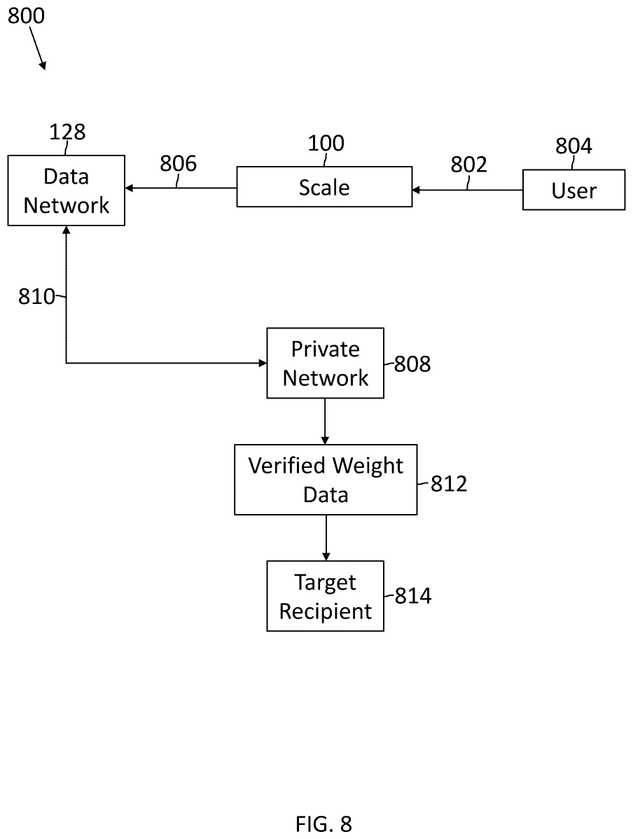

Referring to FIG. 8, the systems and methods of layering security for cellular-enabled user weight data transmission (the “system”) 800 may include the scale 100.

In an embodiment, the scale 100 collects initial weight data 802 from the user 804. Further, the scale 100 may utilize various transmission protocol means, such as, but not limited to USSD message transmission technology, CMDA, SMS, GSM, and/or GPRS technology. Through said transmission protocols, at least one of messages and the initial weight data 802 may be transmitted to a central database where said messages and data 802 are stored.

Upon collection of the initial weight data 802, the scale 100 may encrypt said data 802, thus transforming the initial weight data 802 into encrypted weight data 806. In an embodiment, the scale 100 may encrypt the initial weight data 802 with a shared secret.

In one embodiment, the shared secret may consist of a specific piece of data, such as a Personal Identification Number (PIN) or password. The shared secret may enable two or more parties to securely exchange information. Specifically, after encrypted information is exchanged, the shared secret may enable the parties to decrypt the information, ensuring that only those with access to the shared secret can access the content.

In another embodiment, the shared secret may be shared prior to transmission of the encrypted weight data 806 and/or created at the start of transmission of the encrypted weight data 806. In a nonlimiting example, if the shared secret is shared prior to the transmission, the shared secret may be referred to as a pre-shared key. As a further nonlimiting example, the shared secret may be created at the start of the transmission with a key-agreement protocol. In yet a further nonlimiting example, the shared secret may be at least one of an asymmetric-key algorithm and a symmetric-key algorithm.

In an embodiment, the symmetric-key algorithm may utilize a key to convert the initial weight data 802 into the encrypted weight data 806. In a nonlimiting example, the symmetric-key algorithm may be comprised of at least one of a key and a symmetric block cipher. In a further embodiment, the key may be at least one of a 128-bit key, a 256-bit key, a 576-bit key, and a 2040-bit key. However, any suitable size bit key alternative may comprise the key. In yet another embodiment, the symmetric block cipher may be comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher. However, any suitable symmetric block cipher alternative may be utilized.

Additionally, upon creation of the encrypted weight data 806, the scale 100 may sign said data 806 via a signing algorithm, thus creating a data signature. For example, the encrypted weight data 806 may be cryptographically signed. The encrypted weight data 806 may be signed via the signing algorithm, which may include at least one of Rivest-Shamir-Adleman (RSA) algorithms, EIGamal signature scheme, Digital Signing Algorithm (DSA), and Elliptical Curve Digital Signature Algorithm (ECDSA). For example, the signing algorithm generates a first hash to accompany the encrypted weight data 806.

Further, the scale 100 may connect to the data network 128. In an embodiment, the scale 100 may connect to the data network 128 via the cellular modem. For example, the cellular modem, embedded within the scale 100, may connect to the data network 128. In another example, the cellular modem may connect to the scale 100 via a USB cable. Such a connection to the data network 128 may be achieved via an Access Point Name (APN). As a nonlimiting example, the APN may be a private APN. In an additional embodiment, the APN may require the mobile devices and/or the scale 100 to be authorized prior to accessing the data network 128. The authorization may register the mobile devices and/or the scale 100 via a computing device identifier. The computing device identifier may be at least one of a Subscriber Identification Module (SIM), an International Mobile Equipment Identity (IMEI), and an Integrated Circuit Card Identification Number (IICID).

After the scale 100 connects to the data network 128, the encrypted weight data 806 may be transmitted. For example, the encrypted weight data 806 may be transmitted to a private network 808. In an embodiment, the encrypted weight data 806 may be transmitted from the data network 128 to the private network 808 via a tunnel 810. For example, the tunnel 810 may connect the data network 128 to the private network 808, such that the encrypted weight data 806 may travel from the data network 128 to the private network 808, or vice versa. As a nonlimiting example, the tunnel 810 may be a persistent and fully redundant Internet Protocol Security (IPsec) Virtual Private Network (VPN) tunnel. Moreover, the tunnel 810 may leverage the symmetric-key algorithm to encrypt and protect the encrypted weight data 806 while traveling through the tunnel 810. In another embodiment, the tunnel 810 may also utilize Transport Layer Security (TLS) as another form of protection for transmitting the encrypted weight data 806 through the tunnel 810.

Further, once the encrypted weight data 806 has travelled through the tunnel 810, said data 806 may be received by the private network 808. In an embodiment, the system 800 may generate an acknowledgment that is subsequently sent to the scale 100 upon acceptance of the encrypted weight data 806 by the private network 808.

Upon receipt of the encrypted weight data 806, the private network 808 may verify the data signature of the encrypted data 806. For example, the private network 808 may compute a second hash at ingest of the encrypted weight data 806. Moreover, the second hash may be compared with the first hash. If said first and second hash are a match, then the private network 808 may accept the encrypted weight data 806, thus verifying the authenticity of said data 806. If the first and second hash are not a match the private network 808 may reject the encrypted weight data 806, thus ensuring the data 806 comes from a verified source.

Additionally, the private network 808 may decrypt the encrypted weight data 806 after verifying the first hash and the second hash are a match, thus transforming said data 806 into verified weight data 812. The verified weight data 812 may then be quality controlled and/or stored. Further, the verified weight data 812 may be transmitted to a target recipient 814. In such an embodiment, the verified weight data 812 may be transmitted to one or more of the mobile devices of the target recipient 814. In a further embodiment, the target recipient 814 may be the user 804 whom the verified weight data 812 corresponds to. In another embodiment, the target recipient 814 may be a healthcare provider (e.g., a physician, a nurse, etc.) for the user 804.

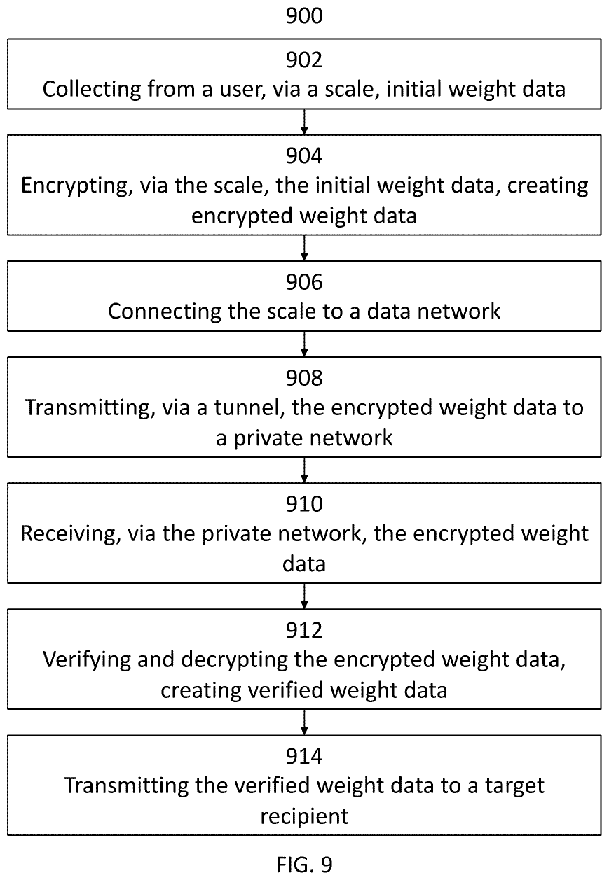

Turning to FIG. 9, a method of layering security for cellular-enabled weight data transmission (the “method”) 900 may be comprised of at least a first step 902.

In the first step 902, the scale 100 may collect the initial weight data 802 from the user 804.

In a second step 904 of the method 900, after collecting the initial weight data 802 from the user 804, the scale 100 may encrypt, and sign said data 802, thus transforming it into encrypted weight data 806. In an embodiment, the scale 100 may encrypt the initial weight data 802 with the shared secret, wherein the shared secret may be the symmetric-key algorithm. In another embodiment, the symmetric-key algorithm may be comprised of the key and the symmetric block cipher. For example, the symmetric block cipher may be AES-256. Moreover, the encrypted weight data 806 may be signed via the signing algorithm, wherein signing the encrypted weight data 806 creates the first hash.

The method 900 may be further comprised of a third step 906, wherein the scale 100 may connect to the data network 128. In an embodiment, the connection may be achieved via the APN.

Additionally, a fourth step 908 may be employed, wherein the encrypted weight data 806 is transmitted to the private network 808 from the scale 100 via the tunnel 810. In an embodiment, the encrypted weight data 806 may first be transmitted from the scale 100 to the data network 128, and then from the data network 128 to the private network 808 via the tunnel 810. In another embodiment, the tunnel 810 may be a persistent and fully redundant IPsec VPN tunnel. Furthermore, the tunnel 810 may also leverage TLS, as an additional form of protection for transmitting the encrypted weight data 806 through the tunnel 810.

A fifth step 910 of the method 900 may entail the private network 808 receiving the encrypted weight data 806. In an embodiment, upon receipt of the encrypted weight data 806, the private network 808 may transmit an acknowledgment to the scale 100.

Furthermore, the method 900 may employ a sixth step 912, wherein the private network 808 may verify and decrypt the encrypted weight data 806. The verification and decryption of the encrypted weight data 806 may transform said data 806 into verified weight data 812. In such a step 912, the second hash may be generated upon receipt of the encrypted weight data 806, wherein said second hash is then compared to the first hash. Such a comparison may act as a verification of the source of the encrypted weight data 806.

The method 900 may further include a seventh step 914, wherein the verified weight data 812 is quality controlled and/or relayed to the target recipient 814. In an embodiment, the target recipient 814 may be the user 804 whom the verified weight data 812 corresponds to and/or a healthcare provider (e.g., a physician, a nurse, etc.) for the user 804.

In an embodiment, at least one of the system 800 and the method 900 may aid in the prevention of a data breach via a cyberattack. For example, layering two or more of: (1) encrypting the initial weight data 802; (2) connecting the scale 100 to the data network 128 via the APN; (3) transmitting the encrypted weight data 806 from the data network 128 to the private network 808 via the tunnel 810; (4) generating the acknowledgement and sending it to the scale 100 upon the private network's 808 acceptance of the encrypted weight data 806; (5) verifying the data signature of the encrypted weight data 806 and decrypting said data 806; and (6) enabling the target recipient 814 to authenticate the sender of the verified weight data 812 may safeguard remote data transmissions of protected healthcare information from cellular-enabled devices. As a nonlimiting example, layering 1, 2, and 3 above ensures that layer 2 reinforces layer 1 and that layer 3 reinforces layer 2. The redundancy in layering security measures creates a tamper proof system for transmitting protected healthcare information. Moreover, the industry at large utilizes the public Internet to transmit information without providing origin authentication. However, both the system 800 and method 900 are able to guarantee the origin and authenticity of protected healthcare information by sending encrypted healthcare information through the tunnel 810 from the data network 128 to the private network 808 and requiring a comparison and match of the first and second hashes. The aforementioned layering ensures protected healthcare information (i.e., the initial 802, encrypted 806, and verified weight data 812) reaches the target recipient 814, while simultaneously proscribing bad actors from accessing said protected information.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A system for improving the security of cellular-enabled weight data transmission by layering security, the system comprising:
a scale;
a wireless network connected to the scale;
a private network connected to the wireless network via a persistent and fully redundant Internet Protocol Security (IPsec) Virtual Private Network (VPN) tunnel;
one or more computer processors; and
a memory having stored therein machine executable instructions, that when executed by the one or more processors, cause the system to:
collect, via the scale, initial weight data from a patient;
encrypt, via the scale, the initial weight data with a shared secret,
wherein encrypting the initial weight data creates encrypted weight data;
generate, via the scale, a first hash using a signing algorithm;
transmit, via the persistent and fully redundant IPsec VPN tunnel, the encrypted weight data from the scale to the private network;
generate, via the private network, a second hash;
compare, via the one or more computer processors, the first hash to the second hash;
decrypt, via the one or more computer processors, the encrypted weight data upon a match of the first and second hash,
wherein decrypting the encrypted weight data creates verified weight data; and
transmit, via the one or more computer processors, the verified weight data to a target recipient.

2. The system of claim 1, wherein the shared secret is a symmetric-key algorithm comprising:
a key; and
a symmetric block cipher.

3. The system of claim 2, wherein the key is comprised of at least one of a 128-bit key, a 256-bit key, a 576-bit key, and a 2040-bit key.

4. The system of claim 2, wherein the symmetric block cipher is comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher.

5. The system of claim 2, wherein the persistent and fully redundant IPsec VPN tunnel leverages the symmetric-key algorithm to encrypt the encrypted weight data while travelling through the persistent and fully redundant IPsec VPN tunnel.

6. The system of claim 1, wherein the scale connects to the wireless network via an Access Point Name (APN).

7. The system of claim 1, wherein the persistent and fully redundant IPsec VPN tunnel is further comprised of Transport Layer Security (TLS).

8. The system of claim 1, wherein the verified weight data is transmitted to one or more client devices of the target recipient.

9. The system of claim 1, wherein the signing algorithm is comprised of at least one of a Rivest-Shamir-Adleman (RSA) algorithm, an EIGamal signature scheme, a Digital Signing Algorithm (DSA), and an Elliptical Curve Digital Signature Algorithm (ECDSA).

10. A method for improving the security of cellular-enabled weight data transmission by layering security, the method comprising:
collecting, via a scale, initial weight data from a patient;
encrypting, via a shared secret generated by the scale, the initial weight data,
wherein encrypting the initial weight data creates encrypted weight data;
signing, via a signing algorithm, the encrypted weight data creating a first hash;
connecting, via an Access Point Name (APN), the scale to a wireless network;
transmitting, via a persistent and fully redundant Internet Protocol Security (IPsec) Virtual Private Network (VPN) tunnel, the encrypted weight data from the scale to a private network;
receiving, via the private network, the encrypted weight data,
wherein upon receipt of the encrypted weight data, the private network generates a second hash;
verifying, via a comparison of the first hash and second hash, the encrypted weight data,
wherein upon a match of the first hash and the second hash, the private network decrypts the encrypted weight data, creating verified weight data; and
transmitting the verified weight data to a target recipient.

11. The method of claim 10, wherein the shared secret is a symmetric-key algorithm comprising:
a key; and
a symmetric block cipher.

12. The method of claim 11, wherein the key is comprised of at least one of a 128-bit key, a 256-bit key, a 576-bit key, and a 2040-bit key.

13. The method of claim 11, wherein the symmetric block cipher is comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher.

14. The method of claim 11, wherein the persistent and fully redundant IPsec VPN tunnel leverages the symmetric-key algorithm to encrypt the encrypted weight data while travelling through the persistent and fully redundant IPsec VPN tunnel.

15. The method of claim 10, wherein the persistent and fully redundant IPsec VPN tunnel is further comprised of Transport Layer Security (TLS).

16. The method of claim 10, wherein the signing algorithm is comprised of at least one of a Rivest-Shamir-Adleman (RSA) algorithm, an EIGamal signature scheme, a Digital Signing Algorithm (DSA), and an Elliptical Curve Digital Signature Algorithm (ECDSA).
